(19) United States
(12) Patent Application Publication
(10) Pub. No.: US 2014/0012738 A1
(43) Pub. Date: Jan. 9, 2014

(54) METHODS AND SYSTEMS FOR MEASURING ACCURACY IN FRAUDULENT TRANSACTION IDENTIFICATION

(71) Applicant: Bennett Woo, Palo Alto, CA (US)

(72) Inventor: Bennett Woo, Palo Alto, CA (US)

(21) Appl. No.: 13/544,849

(22) Filed: Jul. 9, 2012

(51) Int. Cl. G06Q 20/38

(52) U.S. Cl. 705/39

(57) ABSTRACT

Techniques to determine accuracy in identification of fraudulent transactions. In one embodiment, indications from an analyst that financial transactions are fraudulent or not fraudulent are received to determine an error value. An error value may be a false positive error rate based on at least one of a weighted refund holdout, consensus disagreements, peer overturns, an appeal rate, excess negative actions, and a policy error rate. The error value may be a false negative error rate based on at least one of peer overturns, chargebacks, consensus disagreements, and excess passive actions. The false positive error rate is a rate at which the analyst incorrectly identifies the financial transactions as fraudulent and the false negative error rate is a rate at which the analyst incorrectly identifies the financial transactions as non-fraudulent.

### FIELD OF THE INVENTION

The present application relates to social networking and, in particular, systems and methods for measuring accuracy in identification of fraudulent transactions.

### BACKGROUND

Social networking websites provide a dynamic environment in which members can connect to and communicate with other members. These websites may commonly provide online mechanisms allowing members to interact within their preexisting social networks, as well as create new social networks. Members may include any individual or entity, such as an organization or business. Among other attributes, social networking websites allow members to effectively and efficiently communicate relevant information to their social networks.

A member of a social network may highlight or share personal information, news stories, relationship activities, music, and any other content of interest to areas of the website dedicated to the member. Other members of the social network may access the shared content by browsing member profiles or performing dedicated searches. Upon access to and consideration of the content, the other members may react by taking one or more responsive actions, such as providing an opinion about the content, or other feedback. The ability of members to interact in this manner fosters communications among them and helps to realize the goals of social networking websites.

Among other actions that can be taken on social networking websites, users may engage in commercial transactions that involve the purchase of real or virtual goods. Some commercial transactions involving social networking websites may result from fraudulent or unauthorized use of a payment instrument, such as a credit card. Such improper use can result in a chargeback. However, if the number of chargebacks involving a social networking website exceed a certain threshold, the standing of the social networking website with a credit card association can be negatively impacted.

### SUMMARY

To improve financial transaction processing within a social networking system, embodiments of the invention include systems, methods, and computer readable media to determine accuracy in the identification of fraudulent transactions. Indications from an analyst that financial transactions are fraudulent are received. The financial transactions may be a transactions holdout group from a larger number of transactions processed by the analyst. The transactions holdout group may be a predetermined percentage or number of the larger number of transactions processed by the analyst in a period of time. Requests from the analyst to provide refunds for the financial transactions are received. The requests may be the result of decisions by the analyst that the financial transactions are fraudulent. Processing of the refunds for the financial transactions are postponed. The processing may be postponed for a predetermined period of time or until a conclusion can be drawn about the possibility that the related transactions will be subject to chargebacks.

In an embodiment, information about chargebacks associated with the financial transactions is received. An indication of a chargeback for at least one financial transaction from the financial transactions is not received. A false positive based on absence of the chargeback for the at least one financial transaction is determined. The false positive indicates a likelihood that the analyst incorrectly identified a transaction as fraudulent. The false positive may be weighted based on a chargeback arrival curve. An error value associated with the analyst in identifying fraudulent transactions is determined based on the information about chargebacks.

In an embodiment, the error value includes at least one of a false positive error rate and a false negative error rate, wherein the false positive error rate is a rate at which the analyst incorrectly identifies the financial transactions as fraudulent and the false negative error rate is a rate at which the analyst incorrectly identifies the financial transactions as non-fraudulent.

In an embodiment, the error value may be a false positive error rate based on at least one of a weighted refund holdout, consensus disagreements, peer overturns, an appeal rate, excess negative actions, and a policy error rate. The error value may be a false negative error rate based on at least one of peer overturns, chargebacks, consensus disagreements, and excess passive actions.

In an embodiment, the error value is based on averaging of error rate considerations. The error value may be based on weighted averaging of error rate considerations.

In an embodiment, the error value is a combined error rate based on an aggregate false positive error rate and an aggregate false negative error rate. The error value may be based on averaging of an aggregate false positive error rate and an aggregate false negative error rate. The averaging may be weighted according to importance of the aggregate false positive error rate and the aggregate false negative error rate.

Many other features and embodiments of the invention will be apparent from the accompanying drawings and from the following detailed description.

### BRIEF DESCRIPTION OF THE DRAWINGS

FIG. 1 is a network diagram of a system for measuring accuracy in fraudulent transaction identification by an analyst of a social networking system in accordance with an embodiment of the invention.

FIG. 2 is a block diagram of transaction processing involving the social networking system in accordance with an embodiment of the invention.

FIG. 3 illustrates a decision flow to a transaction processing accuracy module in accordance with an embodiment of the invention.

FIGS. 4A-4B illustrate calculated error rates in accordance with an embodiment of the invention.

FIG. 5 illustrates a process for determining accuracy in fraudulent transaction identification in accordance with an embodiment of the invention.

FIG. 6 illustrates an example of a computer system that may be used to implement one or more of the computing devices described herein in accordance with an embodiment of the invention.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

### Social Networking System—General Introduction

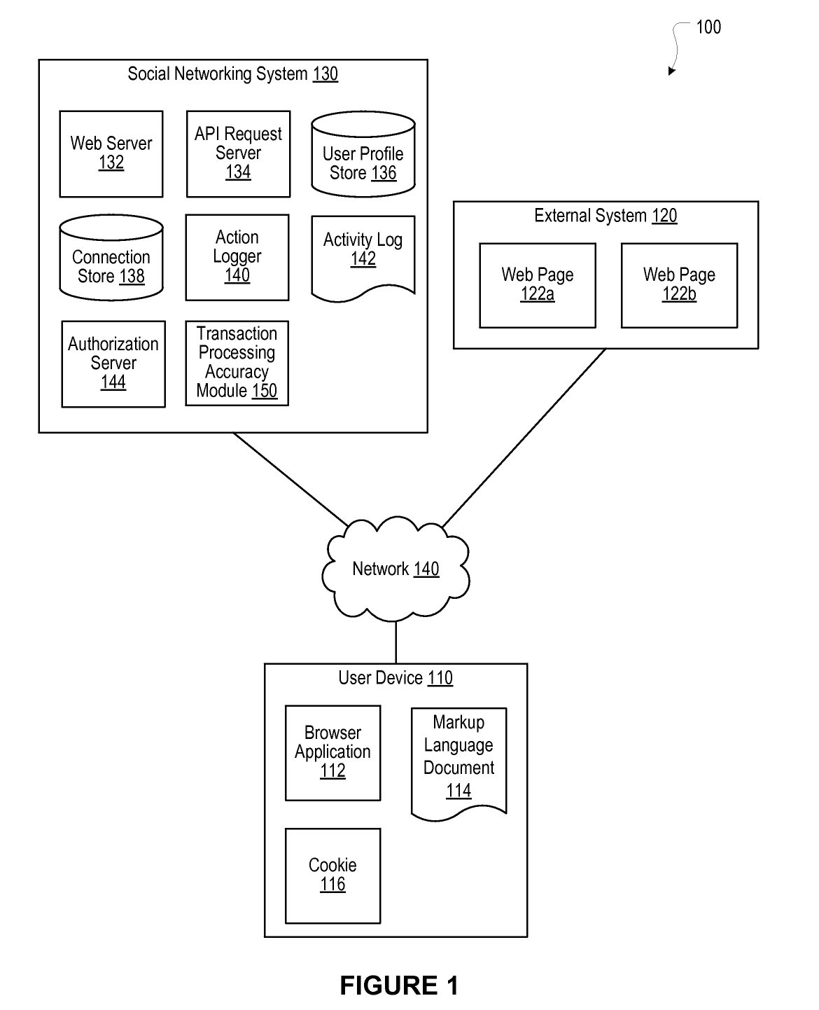

FIG. 1 is a network diagram of a system 100 for measuring accuracy in identification of fraudulent transactions by analysts of a social networking system 130 in accordance with an embodiment of the invention. The system 100 includes one or more user devices 110, one or more external systems 120, the social networking system 130, and a network 140. For purposes of illustration, the embodiment of the system 100, shown by FIG. 1, includes a single external system 120 and a single user device 110. However, in other embodiments, the system 100 may include more user devices 110 and/or more external systems 120. In certain embodiments, the social networking system 130 is operated by a social network provider, whereas the external systems 120 are separate from the social networking system 130 in that they may be operated by different entities. In various embodiments, however, the social networking system 130 and the external systems 120 operate in conjunction to provide social networking services to users (or members) of the social networking system 130. In this sense, the social networking system 130 provides a platform or backbone, which other systems, such as external systems 120, may use to provide social networking services and functionalities to users across the Internet.

The user device 110 comprises one or more computing devices that can receive input from a user and transmit and receive data via the network 140. In one embodiment, the user device 110 is a conventional computer system executing, for example, a Microsoft Windows compatible operating system (OS), Apple® OS X, and/or a Linux distribution. In another embodiment, the user device 110 can be a device having computer functionality, such as a smart-phone, a tablet, a personal digital assistant (PDA), a mobile telephone, etc. The user device 110 is configured to communicate via the network 140. The user device 110 can execute an application, for example, a browser application that allows a user of the user device 110 to interact with the social networking system 130. In another embodiment, the user device 110 interacts with the social networking system 130 through an application programming interface (API) provided by the native operating system of the user device 110, such as iOS and ANDROID™. The user device 110 is configured to communicate with the external system 120 and the social networking system 130 via the network 140, which may comprise any combination of local area and/or wide area networks, using wired and/or wireless communication systems.

In one embodiment, the network 140 uses standard communications technologies and protocols. Thus, the network 140 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 140 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 140 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 110 may display content from the external system 120 and/or from the social networking system 130 by processing a markup language document 114 received from the external system 120 and from the social networking system 130 using a browser application 112. The markup language document 114 identifies content and one or more instructions describing formatting or presentation of the content. By executing the instructions included in the markup language document 114, the browser application 112 displays the identified content using the format or presentation described by the markup language document 114. For example, the markup language document 114 includes instructions for generating and displaying a web page having multiple frames that include text and/or image data retrieved from the external system 120 and the social networking system 130. In various embodiments, the markup language document 114 comprises a data file including extensible markup language (XML) data, extensible hypertext markup language (XHTML) data, or other markup language data. Additionally, the markup language document 114 may include JavaScript Object Notation (JSON) data, JSON with padding (JSONP), and JavaScript data to facilitate lightweight data-interchange between the external system 120 and the user device 110. The browser application 112 on the user device 110 may use a JavaScript compiler to decode the a markup language document 114.

The markup language document 114 may also include, or link to, applications or application frameworks such as FLASH™ or Unity™ applications, the SilverLight™ application framework, etc.

In one embodiment, the user device 110 also includes one or more cookies 116 including data indicating whether a user of the user device 110 is logged into the social networking system 130, which may enable customization of the data communicated from the social networking system 130 to the user device 110.

The external system 120 includes one or more web servers that include one or more web pages 122a, 122b, which are communicated to the user device 110 using the network 140. The external system 120 is separate from the social networking system 130. For example, the external system 120 is associated with a first domain, while the social networking system 130 is associated with a separate social networking domain. Web pages 122a, 122b, included in the external system 120, comprise markup language documents 114 identifying content and including instructions specifying formatting or presentation of the identified content.

The social networking system 130 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure.

Users may join the social networking system 130 and then add connections to any number of other users of the social networking system 130 to whom they desire to be connected. As used herein, the term “friend” refers to any other user of the social networking system 130 to whom a user has formed a connection, association, or relationship via the social networking system 130. For example, in an embodiment, if users in the social networking system 130 are represented as nodes in the social graph, the term “friend” can refer to an edge formed between and directly connecting two user nodes.

Connections may be added explicitly by a user or may be automatically created by the social networking system 130 based on common characteristics of the users (e.g., users who are alumni of the same educational institution). For example, a first user specifically selects a particular other user to be a friend. Connections in the social networking system 130 are usually in both directions, but need not be, so the terms “user” and “friend” depend on the frame of reference. Connections between users of the social networking system 130 are usually bilateral (“two-way”), or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system 130 by Joe, but Joe does not wish to form a mutual connection, a unilateral connection may be established. The connection between users may be a direct connection; however, some embodiments of the social networking system 130 allow the connection to be indirect via one or more levels of connections or degrees of separation.

In addition to establishing and maintaining connections between users and allowing interactions between users, the social networking system 130 provides users with the ability to take actions on various types of items supported by the social networking system 130. These items may include groups or networks (i.e., social networks of people, entities, and concepts) to which users of the social networking system 130 may belong, events or calendar entries in which a user might be interested, computer-based applications that a user may use via the social networking system 130, transactions that allow users to buy or sell items via services provided by or through the social networking system 130, and interactions with advertisements that a user may perform on or off the social networking system 130. These are just a few examples of the items upon which a user may act on the social networking system 130, and many others are possible. A user may interact with anything that is capable of being represented in the social networking system 130 or in the external system 120, separate from the social networking system 130, or coupled to the social networking system 130 via the network 140.

The social networking system 130 is also capable of linking a variety of entities. For example, the social networking system 130 enables users to interact with each other as well as external systems 120 or other entities through an API, a web service, or other communication channels. The social networking system 130 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 130. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 130 modifies edges connecting the various nodes to reflect the relationships and interactions.

The social networking system 130 also includes user-generated content, which enhances a user's interactions with the social networking system 130. User-generated content may include anything a user can add, upload, send, or “post” to the social networking system 130. For example, a user communicates posts to the social networking system 130 from a user device 110. Posts may include data such as status updates or other textual data, location information, images such as photos, videos, links, music or other similar data and/or media. Content may also be added to the social networking system 130 by a third-party. Content “items” are represented as objects in the social networking system 130. In this way, users of the social networking system 130 are encouraged to communicate with each other by posting text and content items of various types of media through various communication channels. Such communication increases the interaction of users with each other and increases the frequency with which users interact with the social networking system 130.

The social networking system 130 includes a web server 132, an API request server 134, a user account store 136, a connection store 138, an action logger 146, an activity log 142, an authorization server 144, and a transaction processing accuracy module 150. In an embodiment of the invention, the social networking system 130 may include additional, fewer, or different components for various applications. Other components, such as network interfaces, security mechanisms, load balancers, failover servers, management and network operations consoles, and the like are not shown so as to not obscure the details of the system.

The user account store 136 maintains information about user accounts, including biographic, demographic, and other types of descriptive information, such as work experience, educational history, hobbies or preferences, location, user behavior, and the like that has been declared by users or inferred by the social networking system 130. Additional user demographics includes, but is not limited to, age, location, birthplace, birth date, home town, current town, country, race, weight, height, marital status, gender, income level, job, educational degrees, and schools attended. User behavior includes, for example, date and time of activities of the user, types of activities of the user, and extent of activities of the user. This information is stored in the user account store 136 such that each user is uniquely identified. The social networking system 130 also stores data describing one or more connections between different users in the connection store 138. The connection information may indicate users who have similar or common work experience, group memberships, hobbies, or educational history. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 130, such as non-person entities, buckets, cluster centers, images, interests, pages, external systems, concepts, and the like are also stored in the connection store 138.

The social networking system 130 maintains data about objects with which a user may interact. To maintain this data, the user account store 136 and the connection store 138 store instances of the corresponding type of objects maintained by the social networking system 130. Each object type has information fields that are suitable for storing information appropriate to the type of object. For example, the user account store 136 contains data structures with fields suitable for describing a user's account and information related to a user's account. When a new object of a particular type is created, the social networking system 130 initializes a new data structure of the corresponding type, assigns a unique object identifier to it, and begins to add data to the object as needed. This might occur, for example, when a user becomes a user of the social networking system 130, the social networking system 130 generates a new instance of a user profile in the user account store 136, assigns a unique identifier to the user account, and begins to populate the fields of the user account with information provided by the user.

The connection store 138 includes data structures suitable for describing a user's connections to other users, connections to external systems 120 or connections to other entities. The connection store 138 may also associate a connection type with a user's connections, which may be used in conjunction with the user's privacy setting to regulate access to information about the user. In an embodiment of the invention, the user account store 136 and the connection store 138 may be implemented as a federated database.

Data stored in the connection store 138, the user account store 136, and the activity log 142 enables the social networking system 130 to generate the social graph that uses nodes to identify various objects and edges connecting nodes to identify relationships between different objects. For example, if a first user establishes a connection with a second user in the social networking system 130, user accounts of the first user and the second user from the user account store 136 may act as nodes in the social graph. The connection between the first user and the second user stored by the connection store 138 is an edge between the nodes associated with the first user and the second user. Continuing this example, the second user may then send the first user a message within the social networking system 130. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 130 (or, alternatively, in an image maintained by another system outside of the social networking system 130). The image may itself be represented as a node in the social networking system 130. This tagging action may create edges between the first user and the second user as well as create an edge between each of the users and the image, which is also a node in the social graph. In yet another example, if a user confirms attending an event, the user and the event are nodes obtained from the user account store 136, where the attendance of the event is an edge between the nodes that may be retrieved from the activity log 142. By generating and maintaining the social graph, the social networking system 130 includes data describing many different types of objects and the interactions and connections among those objects, providing a rich source of socially relevant information.

The web server 132 links the social networking system 130 to one or more user devices 110 and/or one or more external systems 120 via the network 140. The web server 132 serves web pages, as well as other web-related content, such as Java, JavaScript, Flash, XML, and so forth. The web server 132 may include a mail server or other messaging functionality for receiving and routing messages between the social networking system 130 and one or more user devices 110. The messages can be instant messages, queued messages (e.g., email), text and SMS messages, or any other suitable messaging format.

The API request server 134 allows one or more external systems 120 and user devices 110 to call access information from the social networking system 130 by calling one or more API functions. The API request server 134 may also allow external systems 120 to send information to the social networking system 130 by calling APIs. The external system 120, in one embodiment, sends an API request to the social networking system 130 via the network 140, and the API request server 134 receives the API request. The API request server 134 processes the request by calling an API associated with the API request to generate an appropriate response, which the API request server 134 communicates to the external system 120 via the network 140. For example, responsive to an API request, the API request server 134 collects data associated with a user, such as the user's connections that have logged into the external system 120, and communicates the collected data to the external system 120. In another embodiment, the user device 110 communicates with the social networking system 130 via APIs in the same manner as external systems 120.

The action logger 146 is capable of receiving communications from the web server 132 about user actions on and/or off the social networking system 130. The action logger 146 populates the activity log 142 with information about user actions, enabling the social networking system 130 to discover various actions taken by its users within the social networking system 130 and outside of the social networking system 130. Any action that a particular user takes with respect to another node on the social networking system 130 may be associated with each user's account, through information maintained in the activity log 142 or in a similar database or other data repository. Examples of actions taken by a user within the social networking system 130 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 130, the action is recorded in the activity log 142. In one embodiment, the social networking system 130 maintains the activity log 142 as a database of entries. When an action is taken within the social networking system 130, an entry for the action is added to the activity log 142. The activity log 142 may be referred to as an action log.

Additionally, user actions may be associated with concepts and actions that occur within an entity outside of the social networking system 130, such as an external system 120 that is separate from the social networking system 130. For example, the action logger 146 may receive data describing a user's interaction with an external system 120 from the web server 132. In this example, the external system 120 reports a user's interaction according to structured actions and objects in the social graph.

Other examples of actions where a user interacts with an external system 120 include a user expressing an interest in an external system 120 or another entity, a user posting a comment to the social networking system 130 that discusses an external system 120 or a web page 122a within the external system 120, a user posting to the social networking system 130 a Uniform Resource Locator (URL) or other identifier associated with an external system 120, a user attending an event associated with an external system 120, or any other action by a user that is related to an external system 120. Thus, the activity log 142 may include actions describing interactions between a user of the social networking system 130 and an external system 120 that is separate from the social networking system 130.

The authorization server 144 enforces one or more privacy settings of the users of the social networking system 130. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 120, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 120. One embodiment allows the specification of the set of entities to comprise an enumeration of entities. For example, the user may provide a list of external systems 120 that are allowed to access certain information. Another embodiment allows the specification to comprise a set of entities along with exceptions that are not allowed to access the information. For example, a user may allow all external systems 120 to access the user's work information, but specify a list of external systems 120 that are not allowed to access the work information. Certain embodiments call the list of exceptions that are not allowed to access certain information a “block list”. External systems 120 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 144 contains logic to determine if certain information associated with a user can be accessed by a user's friends, external systems 120, and/or other applications and entities. The external system 120 may need authorization from the authorization server 144 to access the user's more private and sensitive information, such as the user's work phone number. Based on the user's privacy settings, the authorization server 144 determines if another user, the external system 120, an application, or another entity is allowed to access information associated with the user, including information about actions taken by the user.

The social networking system 130 also may include the transaction processing accuracy module 150. The transaction processing accuracy module 150 may receive determinations from analysts about whether transactions are fraudulent or not. Based on the determinations of an analyst, the transaction processing accuracy module 150 may determine error values, such as error rates, associated with false positives and false negatives. The error rates may be based on various considerations that can be variously combined, as described in more detail below.

### Accuracy in Fraudulent Transaction Identifications

The social networking system 130 may present its users with access to a variety of offerings. The social networking system 130 and merchants of goods and services distinct from the social networking system 130 may provide their offerings through the social networking system 130. For example, users of the social networking system 130 may subscribe to content providers to access different types of information, such as news, entertainment, traffic reports, job listings, weather reports, and the like. As another example, users also may play online games and participate in other types of entertainment provided by third parties on the platform of the social networking system 130. As yet another example, users may download and access applications built for use with the social networking system 130.

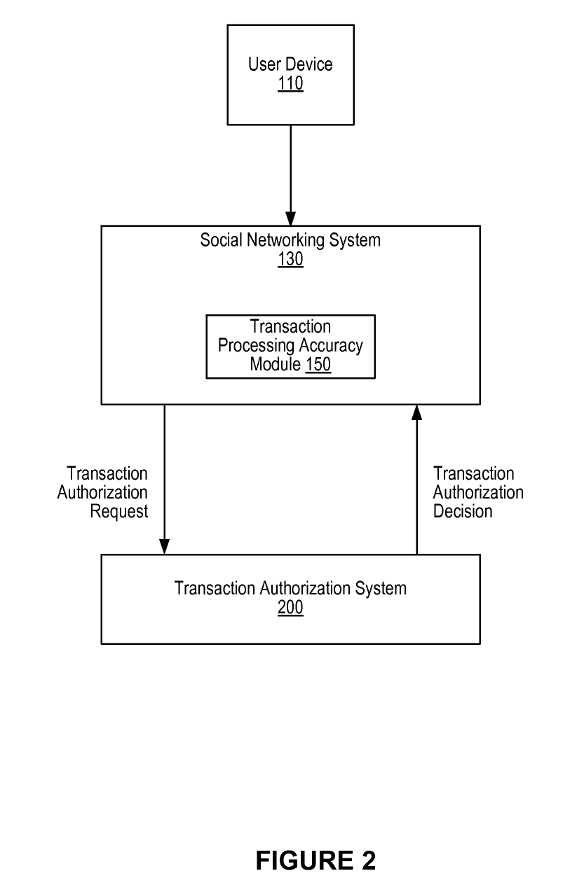

To purchase goods or services offered by or through the social networking system 130, a user may engage in a financial transaction. FIG. 2 illustrates a system for processing a financial transaction in accordance with an embodiment of the invention. The financial transaction may include the provision by the user of information associated with a credit card, or other payment instrument, as a form of payment for desired goods or services. Upon provision to the social networking system 130, the credit card information may be included in a transaction authorization request that is routed to a transaction authorization system 200. The transaction authorization system 200 may include an acquiring bank of the social networking system 130, a credit card issuing bank, and a credit card association. The transaction authorization system 200 allows the social networking system 130 to verify that the credit card of the user is valid and that the user has sufficient credit to cover the purchase.

The transaction authorization system 200 provides, in response to the transaction authorization request, a transaction authorization decision to the social networking system 130. If the transaction authorization system 200 determines that the transaction should be allowed, the transaction authorization decision will be an authorization to proceed with the transaction. After authorization has been received, the transaction may proceed, causing the amount of the transaction to be applied against the credit card of the user. If the transaction authorization system 200 determines that the transaction should be denied, the transaction authorization decision will be a rejection of the transaction. In addition to credit cards, a user may present other types of payment instruments for desired goods and services, such as debit cards, charge cards, etc.

In some instances, a credit card transaction that initially has been authorized by the transaction authorization system 200 nonetheless may be subject to a chargeback. A chargeback may refer to a reversal of a charge against an account of the user. One possible reason for a chargeback is a fraudulent transaction in which a credit card is used without the consent or proper authorization of the cardholder. A chargeback can be initiated when, for example, a cardholder reviews a statement of account and then contacts the issuing bank to establish that a transaction was not authorized by the cardholder. A chargeback often must be initiated within a limited time from the transaction date (e.g., 120 days). The limited time may be referred to as a chargeback window. If successful, a chargeback causes the transaction amount in question to be reversed. In some cases, a credit card association will hold a merchant responsible for chargebacks associated with transactions involving the merchant. To maintain their ability to perform commercial transactions involving the credit card association, merchants, including the social networking system 130, may implement a variety of measures to decrease the incidence of chargebacks.

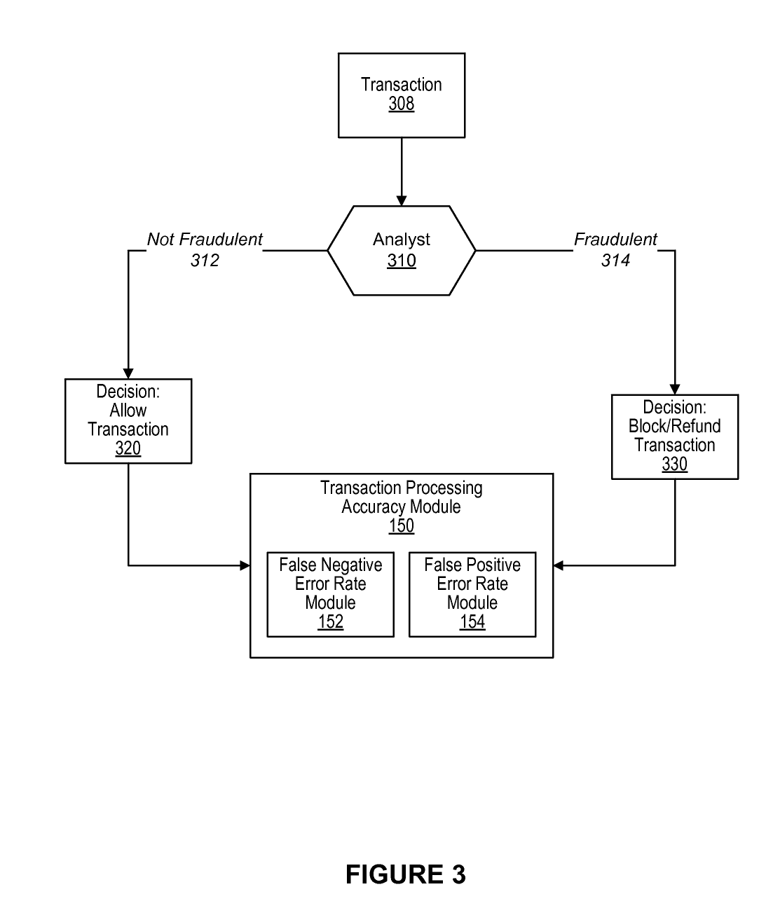

To protect against fraud in its financial transactions, the social networking system 130 may provide for automated assessments about whether attempted transactions are fraudulent or not, and take appropriate action with respect to the transactions. To further protect against fraud in its financial transactions, the social networking system 130 may employ transaction analysts to assess the propriety of the attempted transactions. FIG. 3 illustrates a transaction processing decision flow in accordance with an embodiment of the invention. A transaction for the purchase of goods or services from the social networking system 130 may be attempted by a user. The transaction may be denied or flagged for human review by an analyst 310 who may serve as an administrator for the social networking system 130. During the human review process performed by the analyst 310, a variety of responses to the transaction are possible. For example, the transaction may be blocked or refunded. As another example, the account of the user may be disabled. As yet another example, the credit card or other payment instrument of the user may be rejected. As yet still another example, the transaction may be allowed.

The human review performed by the analyst 310 of a transaction 308 may result in a determination that the transaction 308 is not fraudulent 312 with a corresponding decision to allow 320 the transaction, or a determination that the transaction 308 is fraudulent 314 with a corresponding decision to block or refund 330 the transaction. In either case, the resulting decision may be a correct decision or may be an incorrect decision. An incorrect decision may be a false negative decision or a false positive decision. A false negative decision refers to an incorrect decision of an analyst in identifying a transaction as non-fraudulent. A false positive decision refers to an incorrect decision of an analyst in identifying a transaction as fraudulent.

Decisions made by the analyst 310 may be provided to the transaction processing accuracy module 150 to determine the rate at which the analyst is providing false negative decisions and false positive decisions. The transaction processing accuracy module 150 may include a false negative error rate module 152 and a false positive error rate module 154. The false negative error rate module 152 and the false positive error rate module 154 receive information about decisions made by the analyst regarding whether a transaction is fraudulent or not, as well as other types of information as discussed in more detail below. The false positive error rate module 154 may determine a false positive error rate, or other type of error value, for an analyst based on a variety of error rate considerations including, but not limited to, weighted refund holdout, consensus disagreements, peer overturns, appeal rate, excess negative actions, and policy error rate. The false negative error rate module 152 may determine a false negative error rate, or other type of error value, based on a variety of error rate considerations including, but not limited to, peer overturns, chargebacks, consensus disagreements, and excess passive actions. Other error rate considerations and other combinations of error rate considerations may be employed in the determination of the false negative error rate and the false positive error rate.

A weighted refund holdout may be used to determine an error rate. An analyst may determine that transactions are fraudulent and attempt to process refunds for the transactions. The transaction processing accuracy module 150 may intercede in the attempt to process refunds for certain of the transactions, which constitute a holdout transaction group. The holdout transaction group may be a portion of a larger number of transaction handled by the analyst in a period of time. The transaction processing accuracy module 150 may set aside the processing of the refunds for the holdout transaction group and postpone the processing of refunds for the holdout transaction group to determine if cardholders initiate chargebacks on any of the transactions in the holdout transaction group. The processing may be postponed for a predetermined period of time, a variable period of time, or until a conclusion can be drawn about the possibility that the related transactions will be subject to chargebacks. The initiation of chargebacks may be considered a “source of truth” in more definitively identifying a transaction as fraudulent and determining that a refund is appropriate. If a cardholder initiates a chargeback on a transaction in the holdout transaction group, then the decision by the analyst to provide a refund for the transaction may be considered to be likely correct. If a cardholder does not initiate a chargeback on a transaction in the holdout transaction group and thus the social networking system 130 does not receive an indication of a chargeback, then the decision by the analyst to provide a refund for the transaction may be considered to be likely not correct. In this event, the decision of the analyst to provide a refund may be considered a false positive.

In an embodiment, the holdout transaction group may be a predetermined number or percentage of randomly or non-randomly selected transactions that the analyst has identified for a refund among a larger number of transactions. For example, the holdout transaction group could be 10, 85, 100, or 1000 transactions. As another example, the holdout transaction group could be 5%, 10%, 15%, or any other percentage value of a larger or total number of transactions selected by an analyst for refunds. In an embodiment, the analyst may be unaware of the holdout transaction group.

In an embodiment, consideration of the weighted refund holdout to determine an error rate for false positives may account for a chargeback arrival curve over a chargeback window. The chargeback arrival curve may be a function that describes the likelihood that a chargeback for a transaction will be processed at a given point in time in a chargeback window. Thus, each determination of a false positive for a transaction can be numerically weighted based on the chargeback arrival curve. For example, when the chargeback window is 120 days, after 120 days have passed from the date of a transaction from the holdout transaction group, it may be 100% likely that, according to the chargeback arrival curve, any chargeback that was to occur should have occurred. Thus, a transaction remaining settled after 120 days is a strong indication of a false positive. After, for example, 45 days, it may be less likely that, according to the chargeback arrival curve, a chargeback that is to occur should have occurred (e.g., 60%). Thus, a transaction remaining settled after 45 days is a relatively weaker indication of a false positive. Accordingly, a related numerical value for the false positive associated with the transaction could be discounted. For example, a determination of a false positive may be weighted by a chargeback arrival curve. In an embodiment, the chargeback arrival curve may be based on empirical behavioral data reflecting timing of chargebacks initiated by cardholders over the chargeback window.

Consensus disagreements may be used to determine an error rate. Consensus disagreements refer to conflicts between decisions of an analyst with the decisions of peers of the analyst or others. For example, an analyst may decide that a transaction is fraudulent. If a consensus of others decides the same transaction is not fraudulent, the decision of the analyst may be characterized as a false positive. As another example, an analyst may decide that a transaction is not fraudulent. If a consensus of others decides the same transaction is fraudulent, the decision of the analyst may be characterized as a false negative. In an embodiment, a consensus of others may be a predetermined number or percentage of peers (e.g., majority) who have decided a transaction is not fraudulent.

Peer overturns may be used to determine an error rate. An analyst may make an initial determination about whether an attempted transaction is fraudulent or not. The initial determination may be flagged for further review and provided to a peer of the analyst to make another assessment about the transaction. The assessment by the peer may be based on additional information about the propriety of the transaction. If the peer believes the initial determination is incorrect, then the initial determination is reversed. For example, if the initial determination of the analyst is that the transaction is fraudulent, but the peer decides that the transaction is not fraudulent, then the initial decision may be deemed to be a false positive. As another example, if the initial determination of the analyst is that the transaction is not fraudulent, but the peer decides that the transaction is fraudulent, then the initial decision may be deemed to be a false negative.

An appeal rate may be used to determine an error rate. When an attempted transaction is deemed fraudulent, the social networking system 130 may decide to disable an account with the social networking system 130 of a user associated with the transaction. In response to the disabling of the account, the user may contact the social networking system 130 to appeal the decision to disable the account as incorrect. That a user appeals the disabling of her account may tend to indicate that the identification of a fraudulent transaction was incorrect. Thus, an appeal may be indicative of a false positive. For a particular analyst, the appeal rate may refer to the number of disabled accounts for which an appeal is lodged divided by the total number of disabled accounts.

Excess actions may be used to determine an error rate. The social networking system 130 may determine a number of negative actions taken by its analysts over time. A negative action refers to an action taken by an analyst after a determination that a transaction is fraudulent. An average number or percentage of negative actions over a period of time may be determined for a group of analysts. If a particular analyst has taken more negative action than the average number or percentage, then the amount of negative action above the average may be used to determine a measure of excess negative actions for the analyst. For example, if a group of analysts takes negative action for 5% of transactions over a period of time, and a particular analyst takes negative action for 12% of transactions over the period of time, the analyst is associated with an excess negative action rate of 7%. The excess negative action rate may be indicative of false positives.

Likewise, the social networking system 130 may determine a number of passive, or positive, actions taken by its analysts over time. A passive action refers to non-action of an analyst after a determination that a transaction is not fraudulent so that a transaction can be processed. An average number or percentage of passive actions over a period of time may be determined for a group of analysts. If a particular analyst has taken more passive action than the average number or percentage, then the amount of passive action above the average may be used to determine a measure of excess passive actions for the analyst. For example, if a group of analysts takes passive action for 63% of transactions over a period of time, and a particular analyst takes passive action for 84% of transactions over the period of time, the analyst is associated with an excess passive action rate of 21%. The excess passive action rate may be indicative of false negatives.

Policy violations may also be used to determine an error rate. A policy may be any standard or guideline provided by the social networking system 130 or other entity that governs the management by analysts of fraudulent and non-fraudulent transactions. For example, a credit card may be used for both fraudulent and non-fraudulent transactions. Thus, a policy may provide that, while she should refund amounts fraudulently charged against the credit card, an analyst should not refund amounts that were properly charged. In addition, a policy may provide that use of a credit card in a fraudulent transaction should not cause the analyst to place the credit card on a black list that rejects all attempted transactions with the credit card. As another example, a user may associate a credit card to an account with the social networking system 130. A policy may provide that, when fraudulent use is detected, the credit card should not be blacklisted when a legitimate user associated the credit card with the account and should be blacklisted only when a fraudster associated the credit card with the account. Other policies are possible. When an analyst violates policies, a measure of the policy violations, i.e., a policy error rate, may be indicative of false positives.

Chargebacks may also be used to determine an error rate. A user may initiate a chargeback by contacting her issuing bank about an improper charge to her account. A dispute process may be initiated and the merchant may be required to establish that it rendered service properly. If the merchant does not provide sufficient evidence, the credit card company may debit the transaction amount from the account of the merchant and credit the account of the user. The occurrence of a chargeback may reflect that the original transaction subject to the chargeback was initially fraudulent. Thus, chargebacks may be indicative of false negatives.

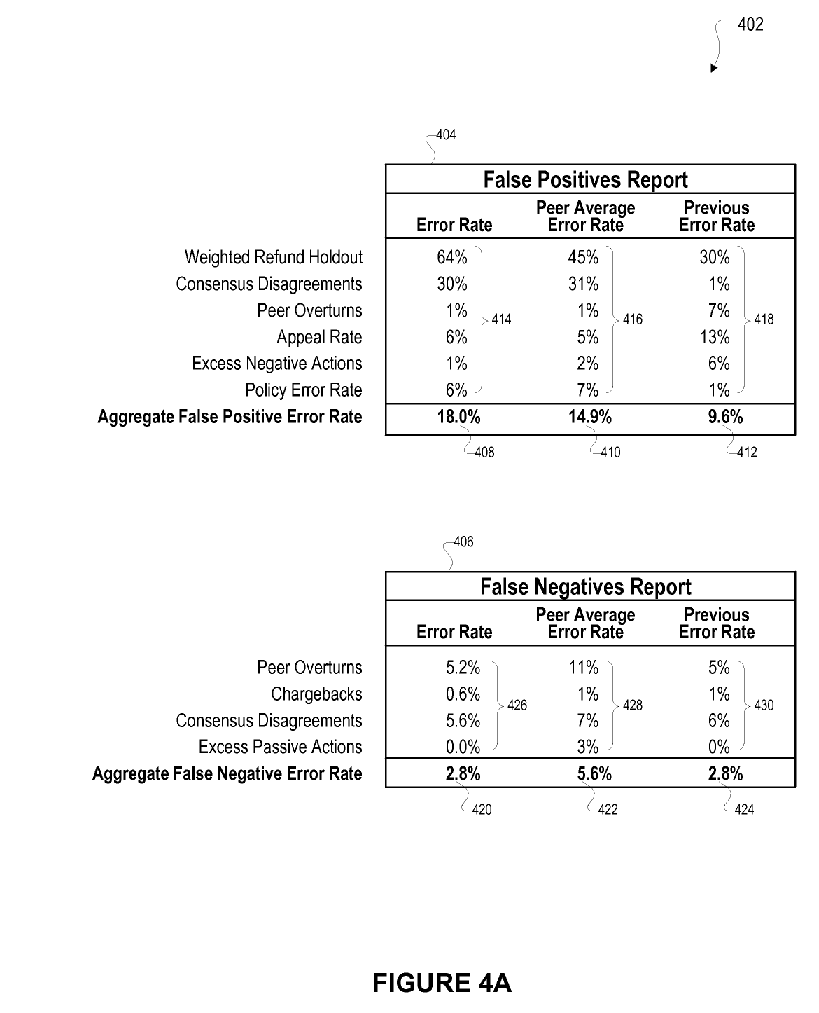

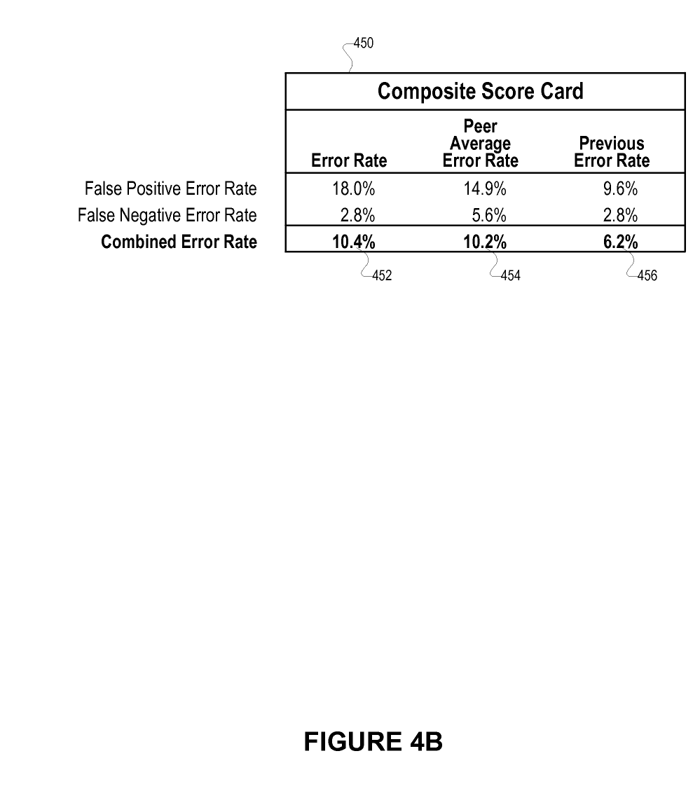

The error rate considerations may be aggregated to provide an overall description of the performance of an analyst and the accuracy of her identifications of fraudulent transactions. FIG. 4A shows calculations of error rate based on error rate considerations in accordance with an embodiment of the invention. An error rate report 402 may be prepared to assess accuracy in the management of fraudulent transactions by an analyst. The error rate report 402 includes a false positives report 404 and a false negatives report 406. The false positives report 404 provides an aggregate error rate 408 of the analyst for a first period of time, an aggregate peer average error rate 410 for a second period of time, and an aggregate previous error rate 412 of the analyst in a prior third period of time.

As shown, the aggregate error rate 408, the aggregate peer average error rate 410, and the aggregate previous error rate 412 are based on the following error rate considerations: weighted refund holdout, consensus disagreements, peer overturns, appeal rate, excess negative actions, and policy error rate. The aggregate error rate 408 is based on an averaging of error rate consideration values 414; the aggregate peer average error rate 410 is based on an averaging of error rate consideration values 416; and, the aggregate previous error rate 412 is based on an averaging of error rate consideration values 418.

In the illustrated example, the aggregate error rate 408 has a value of 18% and the aggregate peer average error rate 410 has a value of 14.9%. These values indicate that the analyst incorrectly identifies transactions as fraudulent at a rate higher than her peers. The aggregate previous error rate 412 of 9.6% for a previous period of time in comparison to the aggregate error rate 408 of 18.0% indicates that in the past the analyst was more accurate in her identification of fraudulent transactions.

The false negatives report 406 provides an aggregate error rate 420 of the analyst for a first period of time, an aggregate peer average error rate 422 for a second period of time, and an aggregate previous error rate 424 of the analyst in a prior third period of time. As shown, the aggregate error rate 420, the aggregate peer average error rate 422, and the aggregate previous error rate 424 are based on the following error rate considerations: peer overturns, chargebacks, consensus disagreements, and excess passive actions. The aggregate error rate 420 is based on an averaging of error rate consideration values 426; the aggregate peer average error rate 422 is based on an averaging of error rate consideration values 428; and, the aggregate previous error rate 424 is based on an averaging of error rate consideration values 430.

In the illustrated example, the aggregate error rate 420 has a value of 2.8% and the aggregate peer average error rate 422 has a value of 5.6%. These values indicate that the analyst incorrectly fails to identify transactions as fraudulent at a rate lower than her peers. The aggregate previous error rate 424 of 2.8% for a previous period of time in comparison to the aggregate error rate 422 of 2.8% indicates that the rate at which the analyst has been incorrectly failing to identify transactions as fraudulent has remained the same over two periods of time.

In an embodiment, other quantitative or qualitative measures of error may be used instead of or in addition to an error rate. For example, an error value may be used as a measure of accuracy in identifying transactions as fraudulent. The error value may be expressed as a number, fraction, percentage, boolean, or other type of value. The error value may be expressed as a number relating to a rate or a number not relating to a rate.

In an embodiment, other error rate considerations and other combinations of error rate considerations may be used to calculate the aggregate error rate 408, the aggregate peer average error rate 410, the aggregate previous error rate 412, the aggregate error rate 420, the aggregate peer average error rate 422, and the aggregate previous error rate 424. Further, error rate considerations used to determine an error rate may be selected or optimized for a particular analyst and her preferences, profile, or performance.

In an embodiment, the aggregate error rate 408, the aggregate peer average error rate 410, the aggregate previous error rate 412, the aggregate error rate 420, the aggregate peer average error rate 422, and the aggregate previous error rate 424 may be determined by a manner other than simple averaging. For example, before their averaging to obtain aggregate values, the error rate consideration values may be weighted according to their importance in indicating the accuracy of an analyst in identifying fraudulent and non-fraudulent transactions. As another example, the error rate consideration values may be weighted according to the number of transactions on which each error rate consideration value is based. As yet another example, error rate consideration values based on a number of transactions that do not satisfy a predetermined threshold may be excluded from calculation of aggregate values.

In an embodiment, for the aggregate error rate 408, the aggregate peer average error rate 410, the aggregate previous error rate 412, the aggregate error rate 420, the aggregate peer average error rate 422, and the aggregate previous error rate 424, the first period of time and the second period of time may be the same or similar time. For example, the period of time may be a day, a week, a month, a year, or any other suitable amount of time. In an embodiment, the first period of time and the third period of time may be consecutive or non-consecutive. For example, the first period of time and the third period of time may be adjacent months. As another example, the first period of time and the third period of time may be the same month in different years.

FIG. 4B shows a composite score card 450 in accordance with an embodiment of the invention. The composite score card 450 includes a combined error rate 452, a combined peer average error rate 454, and a combined previous error rate 456. The combined error rate 452 is based on an averaging of the aggregate error rate 408 and the aggregate error rate 420; the combined peer average error rate 454 is based on an averaging of the aggregate peer average error rate 410 and the aggregate peer average error rate 422; and, the combined previous error rate 456 is based on an averaging of the aggregate previous error rate 412 and the aggregate previous error rate 424. In the illustrated example, the combined error rate 452 has a value of 10.4% and the combined peer average error rate 454 has a value of 10.2%. These values indicate that, with respect to accurately identifying transactions as fraudulent or not fraudulent, the analyst is slightly less accurate than her peers. The combined previous error rate 456 has a value of 6.2%, indicating that the analyst was more accurate in the past in correctly identifying transactions as fraudulent or not fraudulent.

In an embodiment, the combined error rate 452, the combined peer average error rate 454, and the combined previous error rate 456 may be determined by a manner other than simple averaging. For example, if the identification of false positives is deemed more important to the interests of the social networking system 130, the false positive component of the combined error rate 452, the combined peer average error rate 454, and the combined previous error rate 456 could be more heavily emphasized or weighted. As another example, if the identification of false negatives is deemed more important to the interests of the social networking system 130, the false negative component of the combined error rate 452, the combined peer average error rate 454, and the combined previous error rate 456 could be more heavily emphasized or weighted.

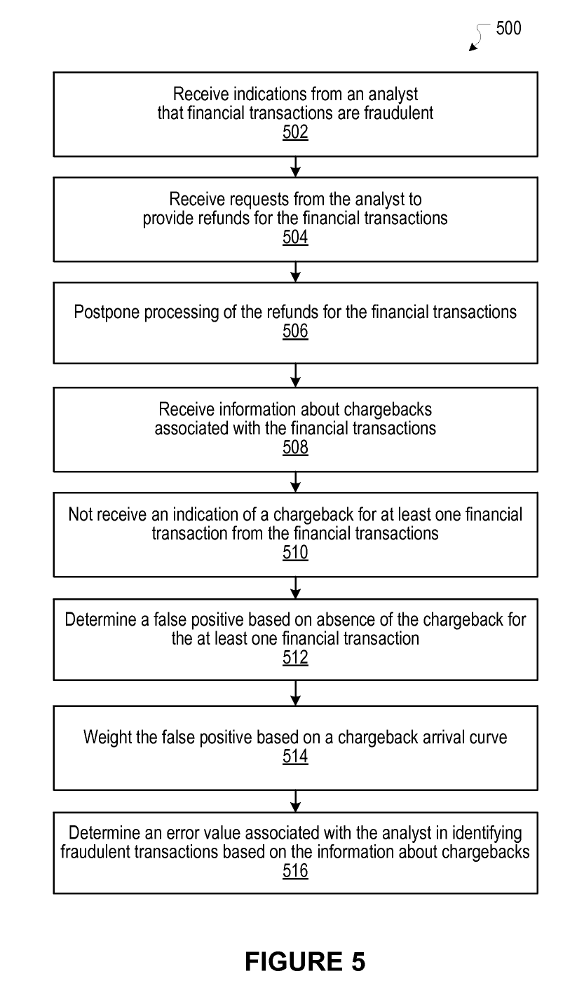

FIG. 5 shows a process 500 for determining accuracy in the identification of fraudulent transactions in accordance with an embodiment of the invention. At a block 502, indications from an analyst that financial transactions are fraudulent are received. The financial transactions may be a transactions holdout group from a larger number of transactions processed by the analyst. The transactions holdout group may be a predetermined percentage or number of the larger number of transactions processed by the analyst in a period of time. At block 504, requests from the analyst to provide refunds for the financial transactions are received. The requests may be the result of decisions by the analyst that the financial transactions are fraudulent. At a block 506, processing of the refunds for the financial transactions are postponed. The processing may be postponed for a predetermined period of time or until a conclusion can be drawn about the possibility that the related transactions will be subject to chargebacks.

At a block 508, information about chargebacks associated with the financial transactions is received. At a block 510, an indication of a chargeback for at least one financial transaction from the financial transactions is not received. At a block 512, a false positive based on absence of the chargeback for the at least one financial transaction is determined. The false positive indicates a likelihood that the analyst incorrectly identified a transaction as fraudulent. At a block 514, the false positive is weighted based on a chargeback arrival curve. At a block 516, an error value associated with the analyst in identifying fraudulent transactions is determined based on the information about chargebacks. In an embodiment, the process 500 maybe performed in whole or in part by the transaction processing accuracy module 150 or the social networking system 130.

### CONCLUSION

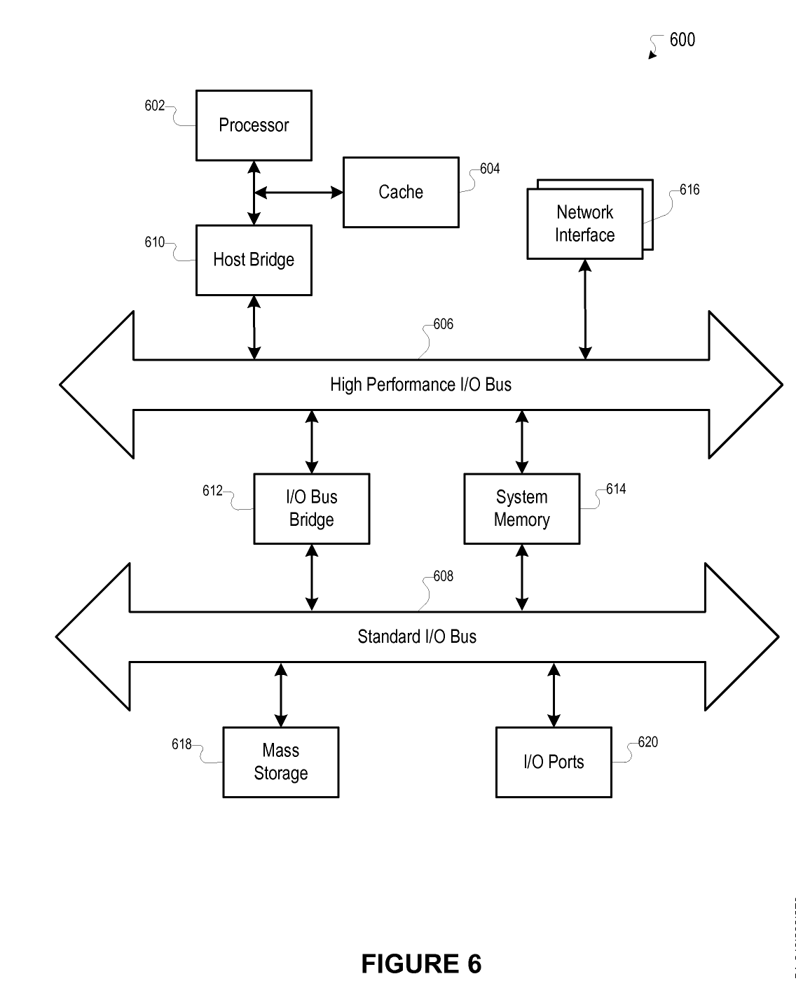

The foregoing processes and features can be implemented by a wide variety of machine and computer system architectures and in a wide variety of network and computing environments. FIG. 6 illustrates an example of a computer system 500 that may be used to implement one or more of the computing devices identified above. The computer system 600 includes sets of instructions for causing the computer system 600 to perform the processes and features discussed herein. The computer system 600 may be connected (e.g., networked) to other machines. In a networked deployment, the computer system 600 may operate in the capacity of a server machine or a client machine in a client-server network environment, or as a peer machine in a peer-to-peer (or distributed) network environment. In an embodiment of the invention, the computer system 600 may be the social networking system 130, the user device 110, the external system 120, or a component thereof. In an embodiment of the invention, the computer system 600 may be one server among many that constitutes all or part of the social networking system 130.

The computer system 600 includes a processor 602, a cache memory 604, and one or more executable modules and drivers, stored on a computer-readable medium, directed to the processes and features described herein. Additionally, the computer system 600 includes a high performance input/output (I/O) bus 606 and a standard I/O bus 608. A host bridge 610 couples the processor 602 to the high performance I/O bus 606, whereas I/O bus bridge 612 couples the two buses 606 and 608 to each other. A system memory 614 and one or more network interfaces 616 couple to the bus 606. The computer system 600 may further include video memory and a display device coupled to the video memory (not shown). Mass storage 618 and I/O ports 620 couple to the bus 608. The computer system 600 may optionally include a keyboard and pointing device, a display device, or other input/output devices (not shown) coupled to the bus 608. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 600, including the input and output of data to and from software applications (not shown). The operating system provides an interface between the software applications being executed on the system and the hardware components of the system. Any suitable operating system may be used, such as the LINUX Operating System; the Apple Macintosh Operating System, available from Apple Computer Inc. of Cupertino, Calif.; UNIX operating systems; Microsoft® Windows® operating systems; BSD operating systems; and the like. Other implementations are possible.

The elements of the computer system 600 are described in greater detail below. In particular, the network interface 616 provides communication between the computer system 600 and any of a wide range of networks, such as an Ethernet (e.g., IEEE 802.3) network, a backplane, etc. The mass storage 618 provides permanent storage for the data and programming instructions to perform the above-described processes and features implemented by the respective computing systems identified above, whereas the system memory 614 (e.g., DRAM) provides temporary storage for the data and programming instructions when executed by the processor 602. The I/O ports 620 may be one or more serial and/or parallel communication ports that provide communication between additional peripheral devices, which may be coupled to the computer system 600.

The computer system 600 may include a variety of system architectures, and various components of the computer system 600 may be rearranged. For example, the cache 604 may be on-chip with processor 602. Alternatively, the cache 604 and the processor 602 may be packed together as a “processor module”, with processor 602 being referred to as the “processor core”. Furthermore, certain embodiments of the invention may neither require nor include all of the above components. For example, peripheral devices coupled to the standard I/O bus 608 may couple to the high performance I/O bus 606. In addition, in some embodiments, only a single bus may exist, with the components of the computer system 600 being coupled to the single bus. Furthermore, the computer system 600 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 600 which, when read and executed by one or more processors, cause the computer system 600 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 600, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 602. Initially, the series of instructions may be stored on a storage device, such as the mass storage 618. However, the series of instructions can be stored on any suitable computer readable storage medium. Furthermore, the series of instructions need not be stored locally, and could be received from a remote storage device, such as a server on a network, via the network interface 616. The instructions are copied from the storage device, such as the mass storage 618, into the system memory 614, and then accessed and executed by processor 602.

Examples of computer readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, or the like means that a particular feature, design, structure, or characteristic described in connection with the embodiment is included in at least one embodiment of the disclosure. The appearances of, for example, the phrase “in one embodiment”, “in an embodiment”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer implemented method comprising:
receiving, by a computer system, information about chargebacks associated with financial transactions; and
determining, by the computer system, an error value associated with an analyst in identifying fraudulent transactions based on the information about chargebacks.

2. The method of claim 1 wherein the financial transactions represent a holdout transactions group from transactions processed by the analyst.

3. The method of claim 2 wherein the holdout transactions group is a predetermined percentage of transactions processed by the analyst.

4. The method of claim 2 further comprising receiving indications from the analyst that the financial transactions are fraudulent.

5. The method of claim 4 further comprising receiving requests from the analyst to provide refunds for the financial transactions.

6. The method of claim 5 further comprising postponing processing of the refunds for the financial transactions.

7. The method of claim 6 further comprising not receiving an indication of a chargeback for at least one financial transaction from the financial transactions.

8. The method of claim 7 further comprising determining a false positive based on absence of the chargeback for the at least one financial transaction.

9. The method of claim 8 further comprising weighting the false positive based on a chargeback arrival curve.

10. The method of claim 1 wherein the error value is a false positive error rate based on at least one of a weighted refund holdout, consensus disagreements, peer overturns, an appeal rate, excess negative actions, and a policy error rate.

11. The method of claim 1 wherein the error value is a false negative error rate based on at least one of peer overturns, chargebacks, consensus disagreements, and excess passive actions.

12. The method of claim 1 wherein the error value is based on a peer average.

13. The method of claim 1 wherein the error value is based on averaging of error rate considerations.

14. The method of claim 1 wherein the error value is based on weighted averaging of error rate considerations.

15. The method of claim 1 wherein the error value is a combined error rate based on an aggregate false positive error rate and an aggregate false negative error rate.

16. The method of claim 1 wherein the error value is based on averaging of an aggregate false positive error rate and an aggregate false negative error rate.

17. The method of claim 16 wherein the averaging is weighted according to importance of the aggregate false positive error rate and the aggregate false negative error rate.

18. The method of claim 1 wherein the error value includes at least one of a false positive error rate and a false negative error rate, wherein the false positive error rate is a rate at which the analyst incorrectly identifies the financial transactions as fraudulent and the false negative error rate is a rate at which the analyst incorrectly identifies the financial transactions as non-fraudulent.

19. A system comprising:
at least one processor; and
a memory storing instructions configured to instruct the at least one processor to perform:
receiving information about chargebacks associated with financial transactions; and
determining an error value associated with an analyst in identifying fraudulent transactions based on the information about chargebacks.

20. A computer storage medium storing computer-executable instructions that, when executed, cause a computer system to perform a computer-implemented method comprising:
receiving information about chargebacks associated with financial transactions; and
determining an error value associated with an analyst in identifying fraudulent transactions based on the information about chargebacks.
